(19) United States
(12) Patent Application Publication
(10) Pub. No.: US 2007/0096652 A1
(43) Pub. Date: May 3, 2007

(54) METHODS FOR FABRICATING STEP-FORMED PATTERNED LAYER AND FRBRICATING RIB OF PLASMA DISPLAY PANEL

(76) Inventors: Chao-Jen Chang, Taoyuan County (TW); Wen-Yu Liu, Miaoli County (TW); Chien-Hsiu Hsu, Yunlin County (TW); Lu-Yi Yang, Taoyuan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,715

(22) Filed: Oct. 28, 2005

(51) Int. Cl. H01J 17/49; G02F 1/1339

(52) U.S. Cl. 313/586; 349/155

(57) ABSTRACT

A method for fabricating a step-formed patterned layer is provided. First, a first patterned photo-resist dry film is formed on a first material layer. Next, a second material layer is formed on the first material layer and covers the first patterned photo-resist dry film. A second patterned photo-resist dry film is then formed on a second material layer, and the patterns of the first patterned photo-resist dry film and the second patterned photo-resist dry film are different and the second patterned photo-resist dry film further exposes the second material layer over the first patterned photo-resist dry film. Subsequently, the first material layer and the second material layer are partially removed by using the first patterned photo-resist dry film and the second patterned photo-resist dry film as a mask. The first patterned photo-resist dry film and the second patterned photo-resist dry film are then removed.

### BACKGROUND OF THE INVENTION

1. Field of the Invention

The present invention generally relates to a method for fabricating a patterned layer, and more particularly, to a method for fabricating a step-formed patterned layer.

2. Description of Related Art

Currently, the more popular patterning processes include screen printing process and photolithography/etching process. Conventionally, in the photolithography/etching process, a photo-resist layer, disposed on a layer, is patterned by using the photolithography process. Then, the layer is etched by using the patterned photo-resist layer as a mask so as to transfer the pattern of the patterned photo-resist layer onto this layer. Next, the patterned photo-resist layer is removed from the layer by using wet or dry etching methods, such as a chemical solution or plasma. In addition, the fabricating of a step-formed patterned layer requires two patterning processes, including repeating the screen printing process or the photolithography/etching process two times.

With the prosperous development of planar displays, the aforementioned patterning processes are frequently implemented in fabricating display panels, wherein, for example, the manufacturing of liquid crystal display panels or plasma display panels requires several patterning processes to from desired layers.

For example, conventionally, a spacer material layer is firstly formed on a substrate and a patterned photo-resist layer is formed on the spacer material layer in the manufacturing of ribs of the plasma display panels. After that, the spacer material layer is sandblasted by using the patterned photo-resist layer as a mask to form ribs.

The most commonly-seen rib structures include stripe-structure, waffle-structure, curve-structure, and step-formed structure. The step-formed ribs are good for ventilating so the time for ventilating can be shortened and impurities in the panels can be reduced. However, due to the limitation of the current development in patterning technology, it usually requires more than two patterning processes or other complicated processes to form the step-formed ribs. As a result, this increases the production costs and leads to low production efficiency.

### SUMMARY OF THE INVENTION

Accordingly, the present invention is directed to a method for fabricating the ribs in the plasma panels in more simplified processes to form step-formed ribs.

The present invention is further directed to a method for forming the step-formed patterned layer. The processes are more simplified so as to promote better production efficiency.

Based on the above-mentioned or other objectives, the present invention provides a method for fabricating ribs in plasma panels. First, a substrate is provided on which a plurality of addressing electrodes covered with a dielectric layer are formed. A first spacer material layer is then formed on the dielectric layer. Next, a first patterned photo-resist dry film is formed on the first spacer material layer. Subsequently, a second spacer material layer is formed on the first spacer material layer and covers the first patterned photo-resist dry film. After that, a second patterned photo-resist dry film is formed on the second spacer material layer, wherein the patterns of the first patterned photo-resist dry film and the second patterned photo-resist dry film are different so as to define a plurality of discharging areas on the substrate and the second patterned photo-resist dry film further exposes the second spacer material layer over the first patterned photo-resist dry film. The addressing electrodes respectively pass through their corresponding discharging areas. Then, the second spacer material layer and the first spacer material layer are sandblasted by using the second patterned photo-resist dry film and the first patterned photo-resist dry film as a mask. Later, the second patterned photo-resist dry film and the first patterned photo-resist dry film are successively removed.

In one embodiment of the present invention, the first patterned photo-resist dry film, for example, comprises a plurality of parallel first striped patterns while the second patterned photo-resist dry film, for example, comprises a plurality of parallel second striped patterns. In addition, the extension direction of the first striped patterns intersects with that of the second striped pattern.

In one embodiment of the present invention, the extension direction of the aforesaid first striped patterns is, for example, perpendicular to that of the second striped patterns.

In one embodiment of the present invention, a method of forming the first spacer material layer is, for example, printing.

In one embodiment of the present invention, a method of forming the second spacer material layer is, for example, printing.

In one embodiment of the present invention, the discharging area has a grid shape.

In one embodiment of the present invention, the first spacer material has, for example, a same material as the second spacer material layer.

In one embodiment of the present invention, the first spacer material has a planar surface.

In one embodiment of the present invention, the second spacer material has a planar surface.

The present invention also provides a method for fabricating a step-formed patterned layer. First, a first patterned photo-resist dry film is formed on a first material layer. Next, a second material layer is formed on the first material layer and covers the first patterned photo-resist dry film. A second patterned photo-resist dry film is then formed on a second material layer, wherein the patterns of the first patterned photo-resist dry film and the second patterned photo-resist dry film are different and the second patterned photo-resist dry film further exposes the second material layer over the first patterned photo-resist dry film. Subsequently, the second material layer and the first material layer are partially removed by using the second patterned photo-resist dry film and the first patterned photo-resist dry film as a mask. Later, the first patterned photo-resist dry film and the second patterned photo-resist dry film are removed.

In one embodiment of the present invention, a method for forming the second material layer on the first material layer comprises printing.

In one embodiment of the present invention, a method for partially removing the first material layer and the second material layer comprises sandblasting the first material layer and the second material layer.

In one embodiment of the present invention, the second spacer material has, for example, a same material as the first spacer material layer.

In one embodiment of the present invention, the first spacer material has a planar surface.

In one embodiment of the present invention, the second spacer material has a planar surface.

Based on the foregoing description, the present invention can form a step-formed patterned layer only by means of the step-formed patterned photo-resist dry films accompanied with a removing step. Therefore, the processes of the present invention are more simplified and accelerated. In addition, if the technology is applied to fabricating the ribs in the plasma display panels, step-formed ribs can be formed. This improves ventilating, reduces impurities in the panels and also promotes the process yield.

The aforementioned objectives and other objectives, features, and advantages of the present invention will be more apparent and easily understood from the following detailed description of the embodiments of the invention when taken in conjunction with the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1 is a flowchart of a process flow for fabricating a step-formed patterned layer of one embodiment of the present invention.

FIGS. 2A˜2E schematically shows cross-sectional views of a process flow for fabricating the step-formed patterned layer of one embodiment of the present invention.

FIG. 3 is a flowchart of a process flow for fabricating a spacer of a plasma display panel of one embodiment of the present invention.

FIGS. 4A-4G schematically shows cross-sectional views of a process flow for fabricating the spacer of the plasma display panel of one embodiment of the present invention.

### DESCRIPTION OF THE EMBODIMENTS

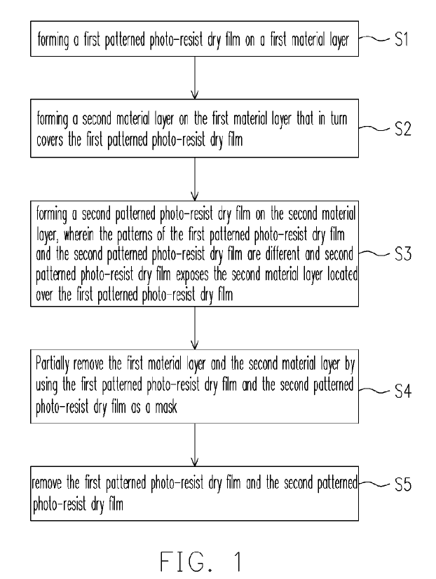

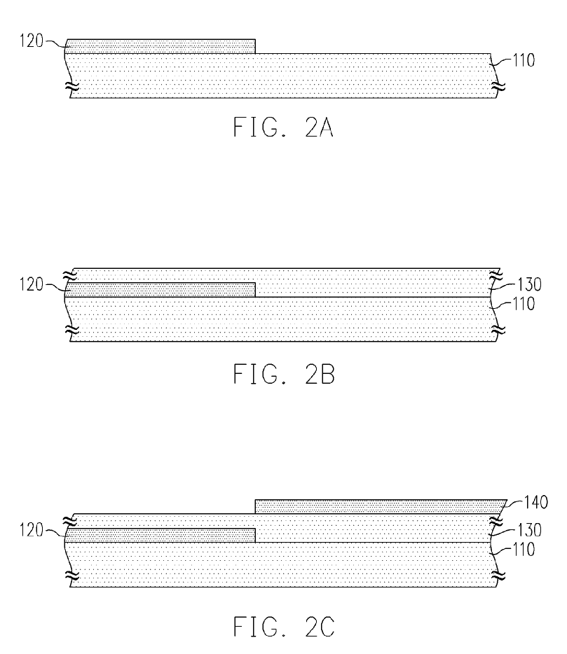

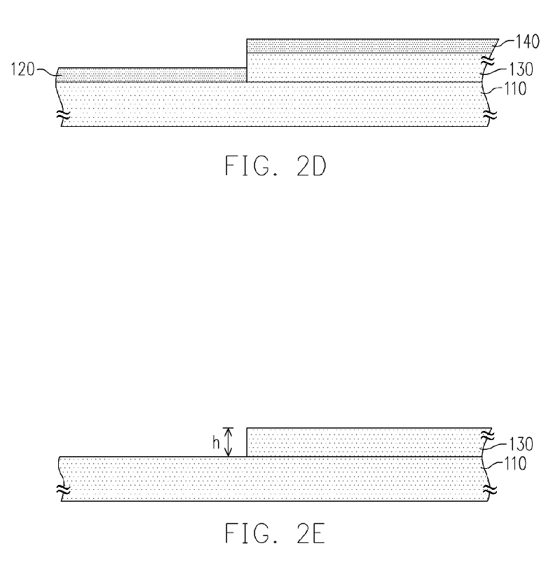

Referring to FIGS. 1 and 2A˜2E, these figures schematically show a flowchart and cross-sectional views of a process flow for fabricating a step-formed patterned layer of one embodiment of the present invention.

First, as shown in FIG. 2A, a first patterned photo-resist dry film 120 is formed on a first material layer 110, wherein the first patterned photo-resist dry film 120 partially exposes the first material layer 110 (step S1).

Next, as shown in FIG. 1B, a second material layer 130 is formed on the first material layer 110 and covers the first patterned photo-resist dry film 120, wherein the second material layer 130, for example, is formed by printing (step S2).

As shown in FIG. 1C, a second patterned photo-resist dry film 140 is formed on the second material layer 130, wherein the patterns of the first patterned photo-resist dry film 120 and the second patterned photo-resist dry film 140 are different and the second patterned photo-resist dry film 140 further exposes the second material layer 130 over the first patterned photo-resist dry film 120 (step S3). In this embodiment, the second patterned photo-resist dry film 140, for example, partially exposes the second material layer 130 disposed on the first patterned photo-resist dry film 120. That is, the first patterned photo-resist dry film 120 is next to the second patterned photo-resist dry film 140. Obviously, in other embodiments, the first patterned photo-resist dry film 120 and the second patterned photo-resist dry film 140, for example, are not intersected or partially overlapped.

Then, as shown in FIG. 2D, the second material layer 130 and the first material layer 110 are partially removed by using the second patterned photo-resist dry film 140 and the first patterned photo-resist dry film 120 as a mask (step S4). For the techniques applied in the present invention, such as the sandblasting of the first material layer 110 and the second material layer 130 or others, for example, wet or dry etching, those skilled in the art may choose an appropriate aforementioned process based on the characteristics of the first material layer 110 and the second material layer 130. Note that only the first material layer 110 underneath the second patterned photo-resist dry film 120, the first material layer 110 underneath the second patterned photo-resist dry film 140, and the second material layer 130 are left after the aforementioned removing step.

Afterwards, as shown in FIG. 1E, the first patterned photo-resist dry film 120 and the second patterned photo-resist dry film 140 are peeled off (step S5). As a result, the left first material layer 110 and the second material layer 130 constitute a step-formed patterned layer with a step-height h.

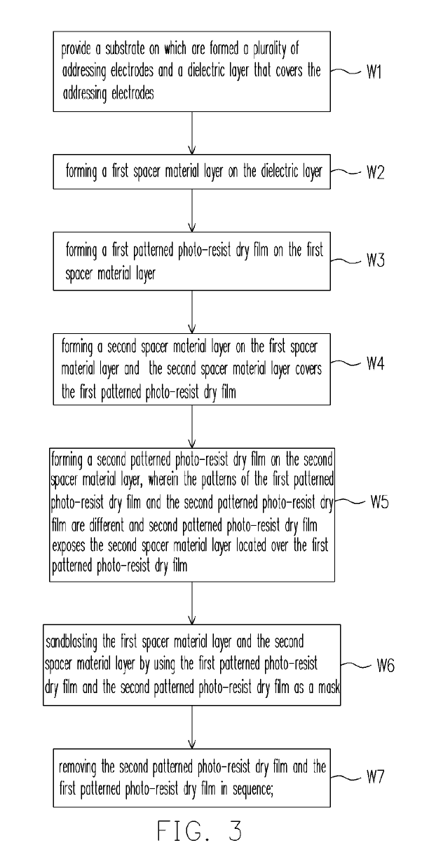

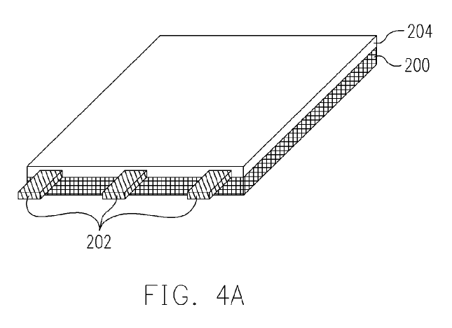

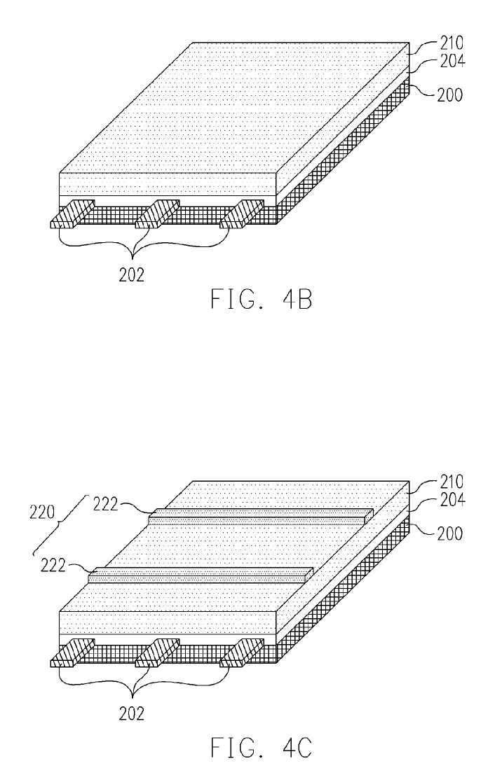

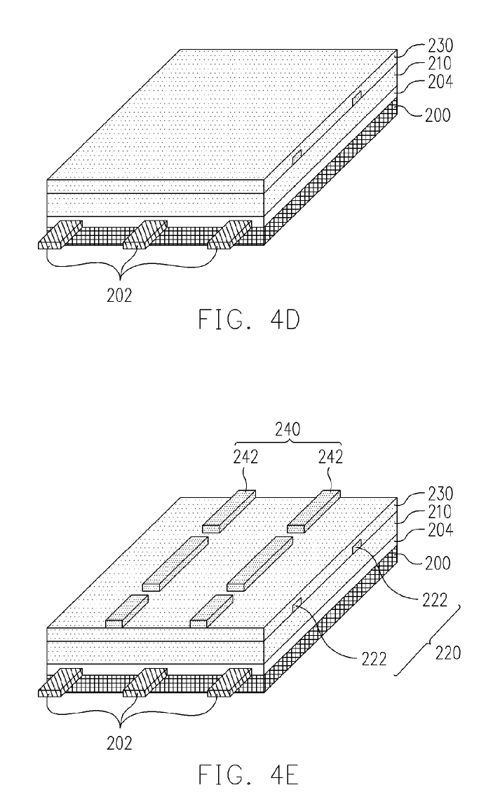

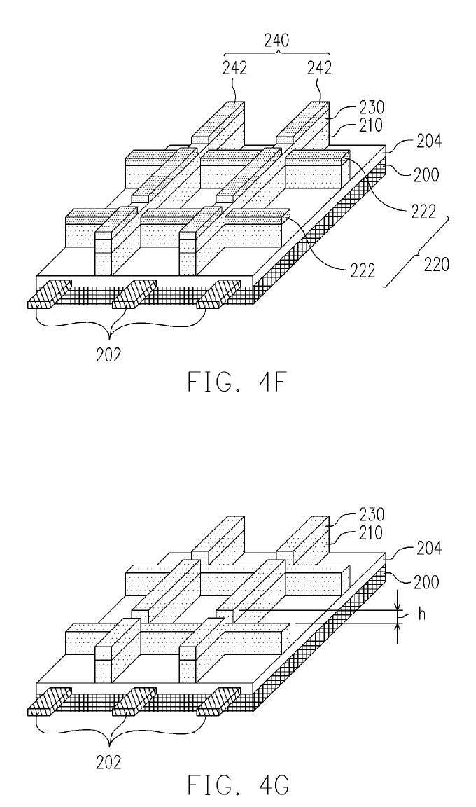

The following method for fabricating the ribs in the plasma display panels is used as an example to describe applications of the present invention. Referring to FIGS. 3 and 4A˜4G, those figures schematically show a flowchart and cross-sectional views of a process flow for fabricating ribs in the plasma display panels of one embodiment of the present invention.

First of all, as shown in FIG. 2A, a substrate 200 is provided, on which a plurality of addressing electrodes 202 and a dielectric layer 204 that covers the addressing electrodes 202 are formed (step W1).

Next, as shown in FIG. 4B to 4D, a first spacer material layer 210 is formed on the dielectric layer 204. A first patterned photo-resist dry film 220 is then formed on the first spacer material layer 210. Following that, a second spacer material layer 230 is formed on the first spacer material layer 210 and then the second spacer material layer 230 covers the first patterned photo-resist dry film 220 (steps W2-W4). In this embodiment, the material of the second spacer material layer 230 is, for example, the same as that of the first spacer material layer 210. In addition, the first spacer material layer 210 and the second spacer material layer 230 are, for example, formed by a printing method, thereby forming an evener surface.

Subsequently, as shown in FIG. 4E, a second patterned photo-resist dry film 240 is formed on the second spacer material layer 230, wherein the patterns of the first patterned photo-resist dry film 220 and the second patterned photo-resist dry film 240 are different and the second patterned photo-resist dry film 240 further exposes the second material layer 230 over the first patterned photo-resist dry film 220 (step W5). A plurality of discharging areas (shown in FIG. 4G) are defined by means of the first patterned photo-resist dry film 220 and the second patterned photo-resist dry film 240 while the addressing electrodes 202 respectively pass through their corresponding discharging areas (shown in FIG. 4G).

It is noticed that the shape of the ribs formed by the present invention are determined by the patterns of the first patterned photo-resist dry film 220 and the second patterned photo-resist dry film 240. For example, if a grid-shaped rib is to be formed in this embodiment, the first patterned photo-resist dry film 220 is constituted by, for example, a plurality of parallel first striped patterns 222, and the second patterned photo-resist dry film 240 is constituted by, for example, a plurality of parallel second striped patterns 242, wherein the extension direction of the first striped patterns 222 is perpendicular to that of the second striped patterns 242 and the second striped pattern 242 further exposes the second spacer material layer 230 over the first striped pattern 220. In other embodiments of the present invention, the patterns of the first patterned photo-resist dry film 220 and the second patterned photo-resist dry film 240 can be different due to the shapes of the ribs. However, the detailed description is not repeated here.

Next, as shown in FIG. 4F, the second spacer material layer 230 and the first spacer material layer 210 are sandblasted by using the second patterned photo-resist dry film 240 and the first patterned photo-resist dry film 220 as a mask (step W6). Meanwhile, the second spacer material layer 230 exposed by the second patterned photo-resist dry film 240 is first removed. Following that, the first spacer material layer 210 exposed by the first patterned photo-resist dry film 220 and the second patterned photo-resist dry film 240 is also removed. Hence, only the first spacer material layer 210 underneath the first patterned photo-resist dry film 220, the first spacer material layer 210 underneath the second patterned photo-resist dry film 240, and the second spacer material layer 230 are left.

As shown in FIG. 4G, the second patterned photo-resist dry film 240 and the first patterned photo-resist dry film 220 are then peeled off in sequence (step W7). As a result, the remaining first spacer material layer 210 and remaining second spacer material layer 230 on the substrate can constitute step-formed ribs with a step-height h.

Note that the step-height h of the patterned layer (ribs) formed by the above-mentioned embodiment is determined by the thickness of the second (spacer) material layer. In more detail, if the patterned layer (ribs) with a larger height h is (are) formed, then the second (spacer) material layer can be formed with greater thickness. Furthermore, the present invention is not limited to only two layers of photo-resist dry film and material layers. Under a reasonable situation, the layers of the photo-resist dry film and material layers can also be increased to form the patterned layer (ribs) with more flexible heights.

In conclusion, the present invention at least provides the following features and advantages.

(1) A step-formed patterned layer is formed by using the step-formed photo-resist dry film accompanied by a removing step. Therefore, the processes are more simplified and accelerated so as to promote production efficiency.

(2) When the present invention is applied to the ribs of plasma display panels, the step-formed ribs can be formed. Therefore, this improves ventilating, reduces impurities in the panels, and further promotes the production yield.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for fabricating ribs in a plasma display panel, comprising:
providing a substrate on which a plurality of addressing electrodes and a dielectric layer are formed and the dielectric layer covers the addressing electrodes;
forming a first spacer material layer on the dielectric layer;
forming a first patterned photo-resist dry film on the first spacer material layer;
forming a second spacer material layer on the first spacer material layer, wherein the second spacer material layer covers the first patterned photo-resist dry film;
forming a second patterned photo-resist dry film on the second spacer material layer, wherein the patterns of the first patterned photo-resist dry film and the second patterned photo-resist dry film are different so as to define a plurality of discharging areas on the substrate, the second patterned photo-resist dry film further exposes the second spacer material layer over the first patterned photo-resist dry film and the addressing electrodes respectively pass through the plurality of discharging areas;
sandblast etching the first spacer material layer and the second spacer material layer by using the first patterned photo-resist dry film and the second patterned photo-resist dry film as a mask; and
removing the second patterned photo-resist dry film and the first patterned photo-resist dry film in sequence.

2. The method for fabricating ribs in a plasma display panel according to claim 1, wherein the first patterned photo-resist dry film comprises a plurality of parallel first striped patterns and the second patterned photo-resist dry film comprises a plurality of parallel second striped patterns, and the extension direction of the first striped patterns intersects with that of the second striped patterns.

3. The method for fabricating ribs in a plasma display panel according to claim 2, wherein the extension direction of some first striped patterns is perpendicular to that of the second striped patterns.

4. The method for fabricating ribs in a plasma display panel according to claim 1, wherein the method for forming the first spacer material layer on the substrate comprises printing.

5. The method for fabricating ribs in a plasma display panel according to claim 1, wherein the method for forming the second spacer material layer on the substrate comprises printing.

6. The method for fabricating ribs in a plasma display panel according to claim 1, wherein the discharging area has a grid shape.

7. The method for fabricating ribs in a plasma display panel according to claim 1, wherein the first spacer material layer has a same material as the second spacer material layer.

8. The method for fabricating ribs in a plasma display panel according to claim 1, wherein the first spacer material layer has a planar surface.

9. The method for fabricating ribs in a plasma display panel according to claim 1, wherein the second spacer material layer has a planar surface.

10. The method for forming a step-formed patterned layer, comprising:
forming a first patterned photo-resist dry film on a first material layer;
forming a second material layer on the first material layer, wherein the second material layer covers the first patterned photo-resist dry film;
forming a second patterned photo-resist dry film on the second material layer, wherein the patterns of the first patterned photo-resist dry film and the second patterned photo-resist dry film are different and the second patterned photo-resist dry film further exposes the second material layer over the first patterned photo-resist dry film;
partially removing the second material layer and the first material layer by using the second patterned photo-resist dry film and the first patterned photo-resist dry film as a mask; and
removing the second patterned photo-resist dry film and the first patterned photo-resist dry film.

11. The method for forming a step-formed patterned layer according to claim 10, wherein the method for forming the second material layer on the first material layer comprises printing.

12. The method for forming a step-formed patterned layer according to claim 10, wherein the method for partially removing the first material layer and the second material layer comprises sandblast etching the first material layer and the second material layer.

13. The method for forming a step-formed patterned layer according to claim 10, wherein the first spacer material layer has a same material as the second spacer material layer.

14. The method for forming a step-formed patterned layer according to claim 10, wherein the first spacer material layer has a planar surface.

15. The method for forming a step-formed patterned layer according to claim 10, wherein the second spacer material layer has a planar surface.
